(19) United States
(12) Patent Application Publication
(10) Pub. No.: US 2025/0014592 A1
(43) Pub. Date: Jan. 9, 2025

(54) INFORMATION PROCESSING METHOD, INFORMATION PROCESSING PROGRAM, AND INFORMATION PROCESSING DEVICE

(71) Applicant: WASEDA UNIVERSITY, Tokyo (JP)

(72) Inventors: Yoichi MATSUYAMA, Tokyo (JP); Mao SAEKI, Tokyo (JP); Shungo NOZAKI, Tokyo (JP)

(21) Appl. No.: 18/895,299

(22) Filed: Sep. 24, 2024

Related U.S. Application Data
(63) Continuation of application No. PCT/JP2023/009268, filed on Mar. 10, 2023.

(30) Foreign Application Priority Data
Mar. 25, 2022 (JP) 2022-049257

(51) Int. Cl. G10L 25/51; G09B 19/04; G10L 15/22

(52) U.S. Cl. CPC G10L 25/51; G09B 19/04; G10L 15/22

(57) ABSTRACT

Provided are an information processing method, an information processing program, and an information processing device for asking a question in consideration of the level of an evaluatee and improving the accuracy of determining the level of the evaluatee. An information processing device includes: an utterance control means for controlling utterance of a question at one level among a plurality of levels determined in advance to a user as an interlocutor; a voice recognition means for performing voice recognition on an answer of the user to the question; a breakdown detection means for detecting a breakdown of the user in the answer; and an ability determination means for determining a level of the user on the basis of at least a level at which the breakdown is detected.

### CROSS-REFERENCE TO RELATED APPLICATIONS

The present application is a bypass continuation application based on and claims the benefit of priority from the prior Japanese patent application No. 2022-049257 filed on Mar. 25, 2022, and PCT Application No. PCT/JP2023/009268 filed Mar. 10, 2023, the entire contents of which are incorporated herein by reference.

### TECHNICAL FIELD

Embodiments relate to an information processing method, an information processing program, and an information processing device.

### BACKGROUND ART

As a conventional technique, an information processing method for scoring an interview by evaluating a response of an interviewee to a question has been proposed (see, for example, Patent Literature 1).

The information processing method disclosed in Patent Literature 1 selects a question from questions prepared in advance, outputs the question to an interviewee, analyzes a response to the question by video and voice, extracts a content feature and a transmission feature of the response, and evaluates the response. In addition, an information processing program uses the evaluation of the response for question selection, and totals the evaluations of all the responses to evaluate the interview.

### CITATION LIST

### Patent Literature

Patent Literature 1: U.S. Pat. No. 10,607,188

### SUMMARY OF INVENTION

### Technical Problem

The above information processing method has the problem that, although a question is selected according to the evaluation of each response, the questions determined in advance are asked according to the development of a talk, and thus a question at an appropriate level cannot be adaptively selected on the basis of the sequential evaluation of the interviewee. There is also the problem that no means for verifying the evaluation result is prepared, and accurate determination is not necessarily performed.

An object of the embodiments is to provide an information processing method, an information processing program, and an information processing device for asking a question in consideration of the level of an evaluatee and improving the accuracy of determining the level of the evaluatee.

### Solution to Problem

In order to achieve the above object, one aspect of the embodiments provides an information processing method, an information processing program, and an information processing device described below.

Aspects of a first embodiment include An information processing method causing a computer to execute: an utterance control step of uttering a question at one level among a plurality of levels determined in advance to an interlocutor; a detection step of detecting a breakdown of the interlocutor in an answer to the question; and a determination step of determining a level of the interlocutor on the basis of at least a level at which the breakdown is detected.

Aspects of a second embodiment include The information processing method according to the first embodiment, wherein the determination step determines the level of the interlocutor for each predetermined unit of the answer, and a question at a level higher than the level is uttered.

Aspects of a third embodiment include The information processing method according to the first or the second embodiment, wherein in a case where a breakdown is detected, a question at a level other than a level at which the breakdown is detected is uttered among questions at the plurality of levels.

Aspects of a fourth embodiment include The information processing method according to any one of the first to the third embodiments, wherein the determination step determines the level of the interlocutor for each predetermined unit of the answer regardless of the detection of the breakdown, and the utterance control step utters a question at the level determined in the determination step.

Aspects of a fifth embodiment include The information processing method according to any one of the first to the fourth embodiments, further causing a computer to execute a display control step of controlling display of an avatar that moves in conjunction with the utterance in the utterance control step.

Aspects of a sixth embodiment include The information processing method according to the fifth embodiment, further causing a computer to execute a motion imparting step of imparting a motion of listening to the answer to the avatar.

Aspects of a seventh embodiment include The information processing method according to the fifth embodiment, further causing a computer to execute a motion imparting step of imparting a motion of responding to the answer to the avatar.

Aspects of an eighth embodiment include An information processing program causing a computer to function as: an utterance control means for controlling utterance of a question at one level among a plurality of levels determined in advance to an interlocutor; a detection means for detecting a breakdown of the interlocutor in an answer to the question; and a determination means for determining a level of the interlocutor on the basis of at least a level at which the breakdown is detected.

Aspects of a ninth embodiment include An information processing device including: an utterance control means for controlling utterance of a question at one level among a plurality of levels determined in advance to an interlocutor; a detection means for detecting a breakdown of the interlocutor in an answer to the question; and a determination means for determining a level of the interlocutor on the basis of at least a level at which the breakdown is detected.

According to the embodiments of the present application, it is possible to ask a question in consideration of the level of an evaluatee and improving the accuracy of determining the level of the evaluator.

### BRIEF DESCRIPTION OF DRAWINGS

FIG. 1 is a schematic view illustrating a configuration example of an information processing system according to an embodiment.

FIG. 2 is a block diagram illustrating a configuration example of an information processing device according to the embodiment.

FIG. 3 is a block diagram illustrating a configuration example of a terminal according to the embodiment.

FIG. 4 is a schematic view illustrating an example of a screen displayed on a display of the terminal.

FIG. 5 is a schematic view illustrating the contents of questions by an utterance control means of the information processing device and answers of a user.

FIG. 6 is a graph illustrating a relationship between the level of ability determination of the information processing device and the lapse of time.

FIG. 7 is a flowchart illustrating an operation example of the information processing device.

### DESCRIPTION OF EMBODIMENTS

### Embodiment

### (Configuration of Information Processing System)

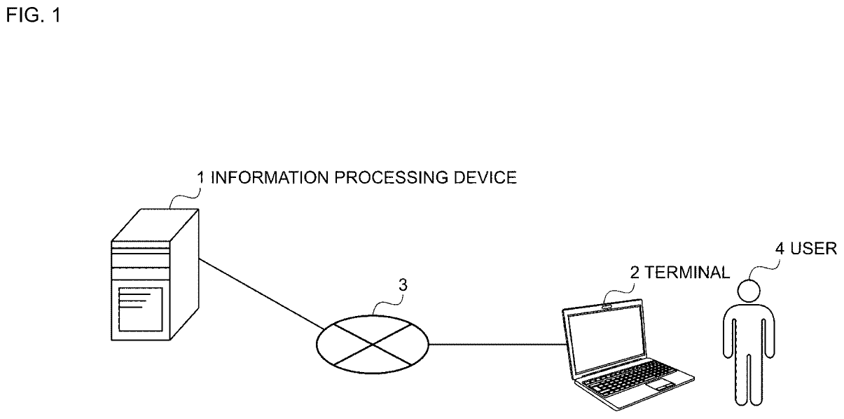

FIG. 1 is a schematic view illustrating a configuration example of an information processing system according to an embodiment.

As an example, the information processing system includes an information processing device 1 that interacts with a user 4 as an interlocutor and determines English conversation ability as a foreign language, and a terminal 2 that reproduces information generated by the information processing device 1 and receives a response of the user 4, which are connected so as to enable communication with each other via a network 3. Note that the information processing device 1 and the terminal 2 may be integrally configured, and in this case, the network 3 can be omitted.

The information processing device 1 is a server type information processing device, operates in response to a request from the user 4 using the terminal 2, and includes electronic components such as a central processing unit (CPU) having a function for processing information in a main body and a flash memory having a function for storing information.

The terminal 2 is a terminal device such a personal computer (PC), a tablet, or a smartphone, and includes electronic components such as a CPU having a function for processing information in a main body, a flash memory, a speaker, a microphone, and a camera.

The network 3 is a communication network enabling high-speed communication, and is, for example, a wired or wireless communication network such as the internet, an intranet, or a local area network (LAN).

In the above configuration, as an example, in order to determine the English conversation ability, the information processing device 1 performs display processing of an avatar on a display unit of the terminal 2 via the network 3, causes the avatar to utter a question, and imparts a motion to the avatar. The information processing device 1 collects an answer of the user 4 to the question using the microphone of the terminal 2, performs voice recognition on the content, and determines the conversation ability for the question. The ability is determined for each predetermined conversation unit such as each topic or each question, and the level of the determination result is appropriately fed back to the selection of the next topic or question. In addition, when the level is determined, a question higher than the determined level is asked in order to make the determined level reliable. In a case where the user 4 gives an answer having incomprehension or non-fluency to the question, it is determined that the previously determined level is correct, and the determination result is output. Hereinafter, the configuration will be described in more detail.

### (Configuration of Information Processing Device)

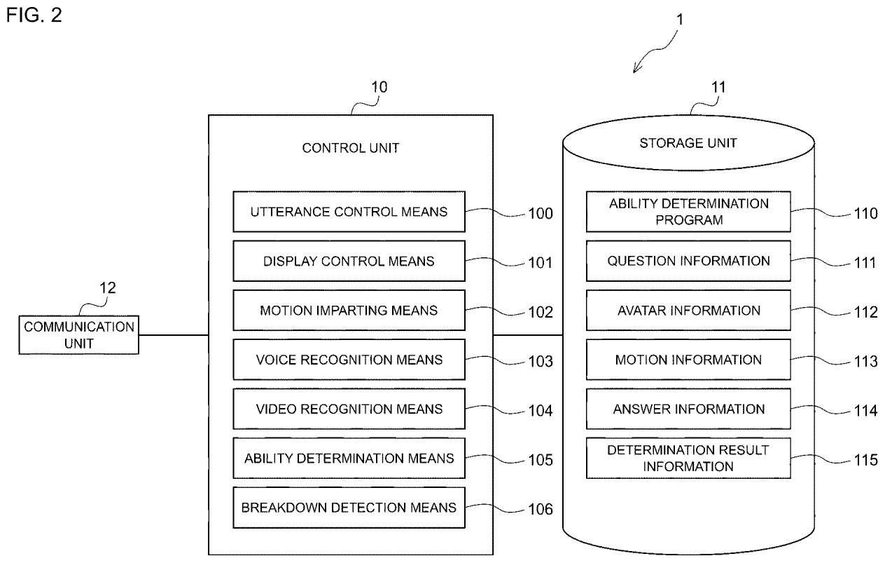

FIG. 2 is a block diagram illustrating a configuration example of the information processing device 1 according to the embodiment.

The information processing device 1 includes a control unit 10 that includes a CPU or the like, controls each unit, and executes various programs, a storage unit 11 that includes a storage medium such as a flash memory and stores information, and a communication unit 12 that communicates with the outside via the network 3.

The control unit 10 functions as an utterance control means 100, a display control means 101, a motion imparting means 102, a voice recognition means 103, a video recognition means 104, an ability determination means 105, a breakdown detection means 106, and the like by executing an ability determination program 110 as an information processing program to be described later.

The utterance control means 100 controls voice utterance in the terminal 2. The utterance control means 100 mainly selects and utters a question according to the level of the user 4 from question information 111 including a plurality of levels of questions prepared in advance. Note that the voice utterance includes not only a question based on the question information 111 but also a greeting to the user 4 and utterance of the user 4 in response to the question, a simple response to an answer, and the like.

The display control means 101 causes the terminal 2 to display an avatar while imparting a motion to the avatar by using avatar information 112 defining an avatar image and motion information 113 defining an avatar motion.

The motion imparting means 102 imparts a motion to the avatar displayed on the terminal 2 by the display control means 101 with reference to the motion information 113 according to the operations of the utterance control means 100, the voice recognition means 103, and the video recognition means 104. For example, an utterance motion is imparted to the avatar in conjunction with the utterance according to the operation of the utterance control means 100. All the motions of the motion information 113 are associated with, for example, certain utterance sentences, and an utterance sentence having the closest inter-sentence distance to the utterance sentence of the motion to be generated is selected. In addition, a motion such as a listening gesture is imparted to the avatar according to the operation of the voice recognition means 103, and a motion reacting to the motion of the user 4 is imparted to the avatar according to the operation of the video recognition means 104. Note that the motion imparting means 102 may impart a motion according to the operations of the ability determination means 105 and the breakdown detection means 106.

The voice recognition means 103 recognizes a voice associated with an answer of the user 4 to the question or the like of the utterance control means 100 received by the terminal 2, and stores the voice in the storage unit 11 as answer information 114. The voice recognition means 103 may further perform language understanding processing on the recognized voice, or the language understanding may be performed by the ability determination means 105. As the voice recognition, for example, a means such as GMM-HMM, DNN-HMM, and End-to-End DNN can be adopted, and as the language understanding, a means such as keyword extraction, a decision tree, and a neural network can be adopted.

The video recognition means 104 recognizes a video including a behavior, a line of sight, a gesture, and the like associated with the answer of the user 4 received by the terminal 2, and stores the video in the storage unit 11 as the answer information 114. As the video recognition, for example, a means such as a neural network can be adopted.

The ability determination means 105 determines the ability of the user 4 on the basis of the contents of the answer information 114 and stores the ability in the storage unit 11 as determination result information 115. As the determination criterion, for example, the common European framework of reference for languages (CEFR) is used. As specific levels, A1, A2, B1, B2, C1, and C2 are prepared, and the level rises in this order. The ability can be determined using a means such as linear regression, a decision tree, and a neural network.

In addition, in a case where the breakdown detection means 106 detects a breakdown, the ability determination means 105 feeds back a provisionally determined level to the utterance control means 100, and causes the utterance control means 100 to select and utter a question according to this level. The feedback operation will be described in detail later. The ability determination means 105 also comprehensively determines the level of the user 4 after answers to a plurality of questions are obtained.

In a case where incomprehension, non-fluency, or a decrease in grammatical accuracy is detected in the answer of the user 4 recognized by the voice recognition means 103 and the video recognition means 104, the breakdown detection means 106 detects this as a breakdown. In the present embodiment, the breakdown is defined as described above on the premise of the case of the English conversation ability determination. However, in the case of a different determination content or a use different from the determination, the definition of the breakdown may be changed according to the determination content or the use. To define the breakdown in a broader concept, the breakdown is defined such that the response content of the user 4 to the content transmitted by the information processing device 1 deviates from the distribution of normal responses, and as a result, an interactive breakdown occurs.

The breakdown detection means 106 detects incomprehension from, for example, a state in which the user requests repetition of utterance or a state in which the user is silent in confusion or in consideration, trying to understand a question. Regarding the latter case, for example, in a case where the voice recognition means 103 or the video recognition means 104 detects, as characteristic motions generated at the time of user's incomprehension, eight motions: diverting the line of sight, bringing the face closer, blinking a lot, turning sideways, moving the line of sight intensely, moving the head intensely, being silent, and reducing the sound volume of utterance, it is determined that the user is in the state of being silent in confusion or in consideration, trying to understand a question.

The breakdown detection means 106 also detects non-fluency from a state in which the user cannot successfully recall linguistic knowledge such as vocabulary, grammar, and pronunciation and is delayed in utterance production. In particular, in a case where silence occurs in the middle of a sentence or a clause, it is determined that the user is delayed in utterance production. This is because, in a case where silence occurs at the beginning or end of a sentence or a clause, this is considered to be caused by content recall such as a lack of background knowledge or a failure in planning of an effective discourse structure.

The storage unit 11 stores the ability determination program 110 that causes the control unit 10 to operate as the respective means 100 to 106 described above, the question information 111, the avatar information 112, the motion information 113, the answer information 114, the determination result information 115, and the like.

### (Configuration of Terminal 2)

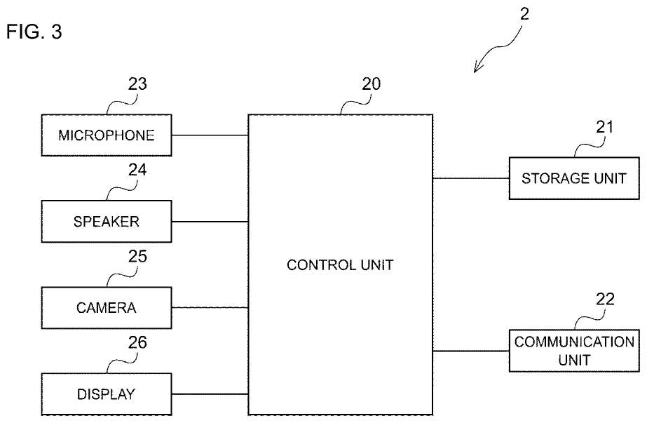

FIG. 3 is a block diagram illustrating a configuration example of the terminal 2 according to the embodiment.

The terminal 2 includes a control unit 20 that includes a CPU or the like, controls each unit, and executes various programs, a storage unit 21 that includes a storage medium such as a flash memory and stores information, a communication unit 22 that communicates with the outside via the network 3, a microphone 23 that converts an input voice of the user 4 into an electric signal, a speaker 24 that converts a signal input from the control unit 20 into a voice and outputs the voice, a camera 25 that captures an image of the user 4 and outputs a video signal, and a display 26 such as an LCD that displays an image, a video, a character, and the like. The terminal 2 also includes an operation unit (a keyboard, a mouse, a trackpad, a touch panel) (not illustrated) or the like that receives an operation from the user 4.

Although the information processing device 1 and the terminal 2 are described as separate devices, some or all of the means of the information processing device 1 may be provided in the terminal 2, and the design may be appropriately changed without departing from the gist of the invention.

### (Operation of Information Processing Device)

Next, effects of the present embodiment will be discretely described in (1) Basic Operation, (2) Introduction Operation, (3) Level Check Operation, and (4) Push-up Operation.

### (1) Basic Operation

First, the user 4 operates the terminal 2 to request English conversation ability determination, for example. The terminal 2 communicates with the information processing device 1 via the network 3, and requests the information processing device 1 to determine English conversation ability.

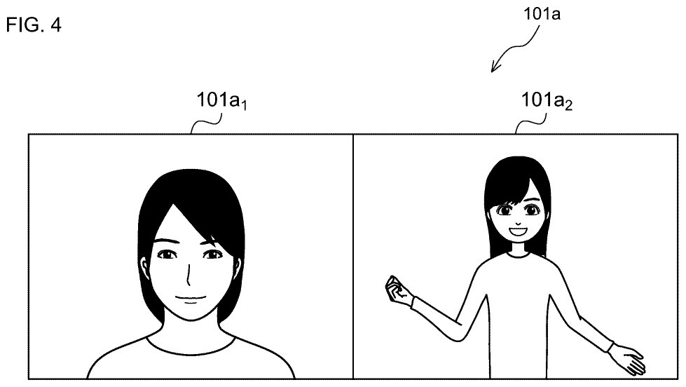

Upon receiving the request for English conversation ability determination from the terminal 2, the information processing device 1 issues an instruction to the utterance control means 100, the display control means 101, and the motion imparting means 102 and perform display processing of an avatar on the display 26 of the terminal 2 as illustrated in FIG. 4.

FIG. 4 is a schematic view illustrating an example of a screen displayed on the display 26 of the terminal 2.

A screen 101a includes an area 101a1 for displaying a video of the user 4 captured by the camera 25 of the terminal 2 and an area 101a2 for displaying an avatar. The area 101a1 is mainly displayed for reference for the user 4, but may not be displayed.

The display control means 101 and the motion imparting means 102 impart a motion to the avatar displayed in the area 101a2, and the utterance control means 100 causes the speaker 24 to output a voice.

In addition, reactions (a voice, an expression, a motion, and the like) of the user 4 to the screen 101a displayed on the display 26 and the voice output from the speaker 24 are input to the information processing device 1 through the microphone 23 and the camera 25 of the terminal 2, and are individually recognized by the voice recognition means 103 and the video recognition means 104 of the information processing device 1.

Before describing the following “(2) Introduction Operation”, “(3) Level Check Operation”, and “(4) Push-up Operation”, the basic operation of each means of the information processing device 1 will be described.

The utterance control means 100 of the information processing device 1 controls the voice utterance of the avatar in the terminal 2. The utterance control means 100 mainly selects and utters a question according to the level of the user 4 from the question information 111 including a plurality of levels of questions prepared in advance.

In addition, the display control means 101 of the information processing device 1 causes the terminal 2 to display an avatar using the avatar information 112 defining an avatar image and the motion information 113 defining an avatar motion, and the motion imparting means 102 of the information processing device 1 imparts a motion to the avatar displayed on the terminal 2 by the display control means 101 with reference to the motion information 113 according to the operations of the utterance control means 100, the voice recognition means 103, and the video recognition means 104. A motion (listening motion) such as a listening gesture is imparted to the avatar according to the operation of the voice recognition means 103, and a motion (reaction) reacting to the motion of the user 4 is imparted to the avatar according to the operation of the video recognition means 104. These motions encourage self-disclosure of the user 4.

In addition, the voice recognition means 103 of the information processing device 1 recognizes a voice associated with an answer of the user 4 to the question or the like of the utterance control means 100 received by the terminal 2, and stores the voice in the storage unit 11 as the answer information 114. The voice recognition means 103 further performs language understanding processing on the recognized voice.

In addition, the video recognition means 104 of the information processing device 1 recognizes a video including a behavior, a line of sight, a gesture, and the like associated with the answer of the user 4 received by the terminal 2, and stores the video in the storage unit 11 as the answer information 114.

In addition, the ability determination means 105 of the information processing device 1 determines the ability of the user 4 on the basis of the contents of the answer information 114, and stores the ability in the storage unit 11 as the determination result information 115.

In addition, in a case where incomprehension or non-fluency is detected in the answer of the user 4 recognized by the voice recognition means 103 and the video recognition means 104, the breakdown detection means 106 of the information processing device 1 detects this as a breakdown.

Hereinafter, the specific operation of the information processing device 1 for determining the English conversation ability of the user 4 while displaying the avatar will be described.

### (2) Introduction Operation

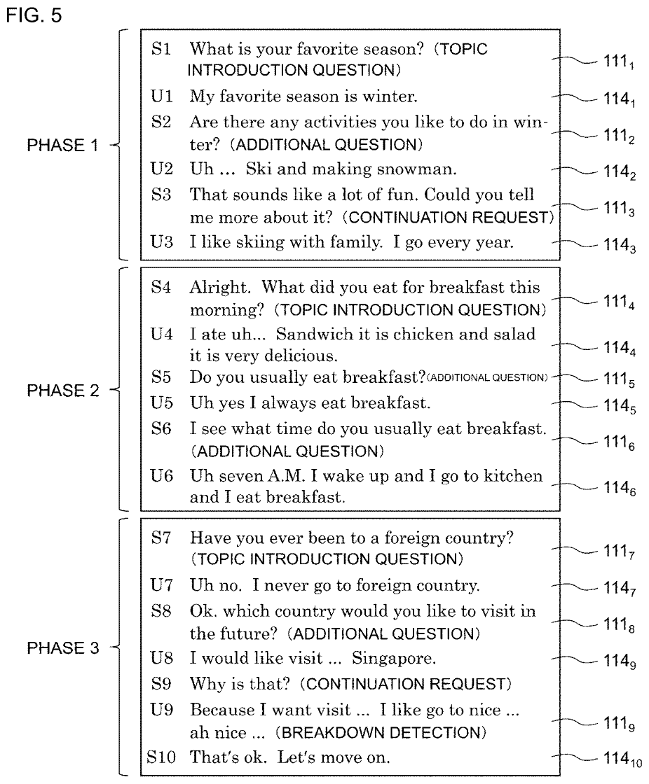

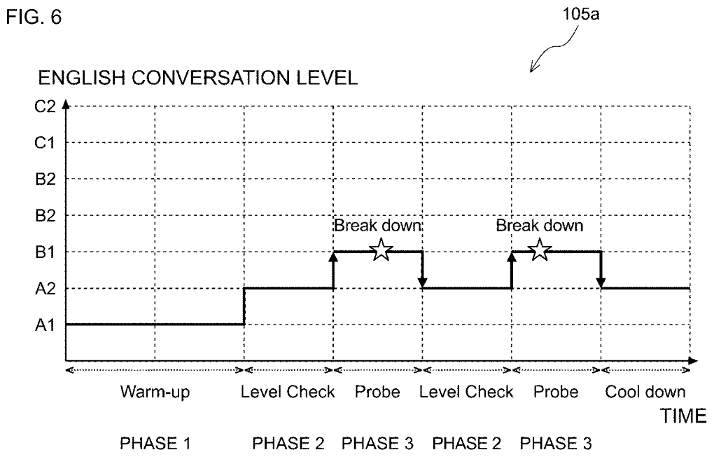

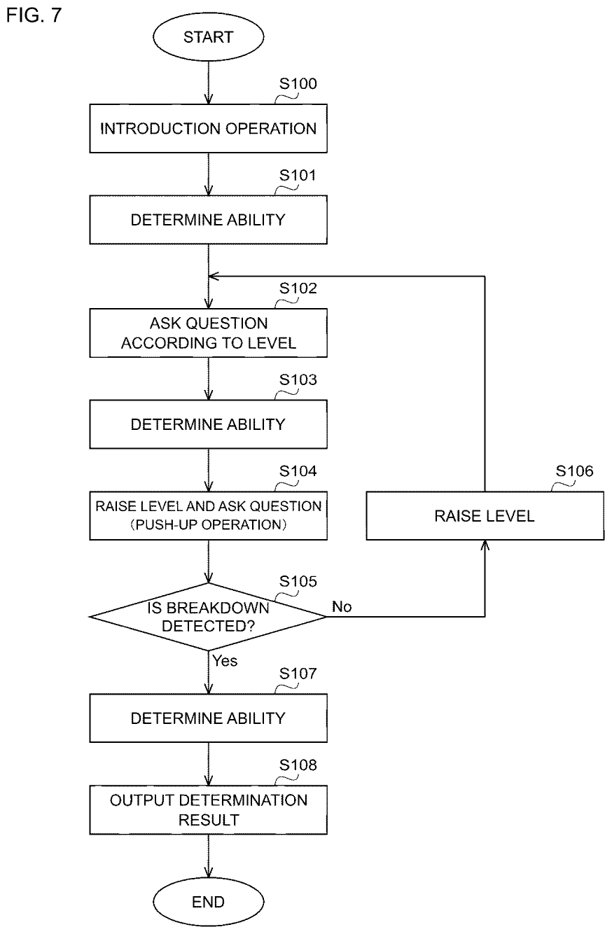

FIG. 5 is a schematic view illustrating a content example of questions (S1 to S10) by the utterance control means 100 of the information processing device 1 and answers (U1 to U9) of the user 4. A phase 1 represents the contents of questions and answers at the time of the introduction operation, a phase 2 represents the contents of questions and answers at the time of the level check operation, and a phase 3 represents the contents of questions and answers at the time of the push-up operation. In addition, FIG. 6 is a graph illustrating a relationship between the level of ability determination of the information processing device 1 and the lapse of time. Moreover, FIG. 7 is a flowchart illustrating an operation example of the information processing device 1.

First, the information processing device 1 causes the avatar to utter a question at the level A1, for example, while imparting a motion to the avatar by the utterance control means 100, the display control means 101, and the motion imparting means 102 so as to perform the introduction operation of making a relatively simple conversation such as a greeting and a small talk with the user 4 to relax the tension and grasp a rough level (S100), and determines the ability of the user 4 by the ability determination means 105 while recognizing the answer, expression, and motion of the user 4 by the voice recognition means 103 and the video recognition means 104 (S101) (a phase 1 in FIG. 6).

Specifically, as illustrated in the phase 1 of FIG. 5, the utterance control means 100, the display control means 101, and the motion imparting means 102 ask a topic introduction question such as “What is your favorite season?” (S1) using the avatar.

In a case where the user 4 answers, for example, “My favorite season is winter.” (U1) to this question, the voice recognition means 103 and the video recognition means 104 recognize the answer, expression, and motion of the user 4. At the same time, the ability determination means 105 determines the ability of the user 4. For example, it is assumed that the level is determined to be the CEFR A2 level.

Next, in order to confirm that the user 4 can reliably make a conversation at the A2 level, the utterance control means 100, the display control means 101, and the motion imparting means 102 ask an additional question such as “Are there any activities you like to do in winter?” (S2).

In a case where the user 4 answers, for example, “Uh . . . . Ski and making snowman.” (U2) to this question, a continuation request such as “That sounds like a lot of fun. Could you tell me more about it?” (S3) is further made. Here, it is assumed that the user 4 answers “I like skiing with family. I go every year.” (U3).

Note that the number of additional questions may be 0 or may be 1 or more as long as the ability determination means 105 can confirm the determination result.

### (3) Level Check Operation

Next, as illustrated in the phase 2 of FIG. 5, the utterance control means 100, the display control means 101, and the motion imparting means 102 ask a topic introduction question such as “Alright. What did you eat for breakfast this morning?” (S4) using the avatar according to the A2 level that is the ability determined in step S101 (S102).

In a case where the user 4 answers, for example, “I ate uh . . . . Sandwich it is chicken and salad it is very delicious.” (U4) to this question, the voice recognition means 103 and the video recognition means 104 recognize the answer, expression, and motion of the user 4. At the same time, the ability determination means 105 determines the ability of the user 4 (S103) (a phase 2 in FIG. 6). For example, it is assumed that the level is determined to be the CEFR A2 level. Although steps S102 and S103 may be performed once, in the present embodiment, the ability is determined by asking an additional question a plurality of times in order to confirm that the user 4 can reliably make a conversation at the A2 level. Note that the ability determination may be performed for each question, or the ability determination may be performed for each predetermined unit such as a plurality of questions or a topic.

For example, the utterance control means 100, the display control means 101, and the motion imparting means 102 ask an additional question such as “Do you usually eat breakfast?” (S5).

In a case where the user 4 answers, for example, “Uh yes I always eat breakfast.” (U5) to this question, a yet additional question such as “I see what time do you usually eat breakfast.” (S6) is further asked. Here, it is assumed that the user 4 answers “Uh seven A.M. I wake up and I go to kitchen and I eat breakfast.” (U6).

As a result of the voice recognition means 103 and the video recognition means 104 recognizing the answer, expression, and motion of the user 4 in the above conversation, the answer is made without any problem, and thus the ability determination means 105 provisionally determines the ability of the user 4 as the CEFR A2 level (S103). Strictly speaking, since the level has not been fixed, it is determined that the ability is the CEFR A2 level or higher (that is, the lower limit level is A2).

### (4) Push-Up Operation

Next, in order to verify that the determination result determined in the above level check operation is correct, the utterance control means 100, the display control means 101, and the motion imparting means 102 raise the level higher than the level of the determination result in step S103, and ask a topic introduction question at the CEFR B1 level (S104). Specifically, as illustrated in the phase 3 of FIG. 5, a question such as “Have you ever been to a foreign country?” (S7) is asked using the avatar. Note that the level is not limited to be raised by 1, and may be raised by 2 or more, the degree of the level to be raised may be changed depending on the answer, and the level may also be lowered according to the purpose.

In a case where the user 4 answers, for example, “Uh no. I never go to foreign country.” (U7) to this question, the voice recognition means 103 and the video recognition means 104 recognize the answer, expression, and motion of the user 4. Since the breakdown detection means 106 detects no incomprehension or non-fluency in the recognized answer of the user 4 (S105; No), the level is supposed to be further raised to ask a question (S106). However, in the present embodiment, in order to confirm that the user 4 can reliably make a conversation at the B1 level, an additional question at the B1 level is asked a plurality of times.

Next, in order to confirm that the user 4 can reliably make a conversation at the B1 level, the utterance control means 100, the display control means 101, and the motion imparting means 102 ask an additional question such as “Ok. which country would you like to visit in the future?” (S8).

In a case where the user 4 answers, for example, “I would like visit . . . . Singapore.” (U8) to this question, the breakdown detection means 106 detects non-fluency, but further makes a continuation request such as “Why is that?” (S9) in order to check whether this is correct.

For example, in a case where the user 4 answers, for example, “Because I want visit . . . . I like go to nice . . . ah nice . . . ” (U9) to this question, the breakdown detection means 106 determines that the breakdown is detected since the non-fluency is detected in the recognized answer of the user 4 (S105; Yes), and in response to the answer, “That's ok. Let's move on.” (S10) is uttered.

In a case where the breakdown detection means 106 detects the breakdown (step S105; Yes), the ability determination means 105 determines that the ability of the user 4 is not the CEFR level B1 but the level A2 (S107) (a phase 3 in FIG. 6). The ability determination means 105 also outputs the determination result to the user 4 or any person such as an administrator other than the user 4 (S108).

On the other hand, in a case where the breakdown detection means 106 detects no breakdown with respect to a plurality of questions at the level B1 (step S105; No), the determination result in step S103 is corrected to raise the level to B2 (S106), and steps S102 to S106 are repeated to finally determine the ability (S107).

In addition, the ability determination means 105 may feed back the level determined in step S107 described above to the utterance control means 100 as a provisional determination result, and may cause the utterance control means 100 to select and utter a question according to this level again (S102). In this case, the ability determination means 105 may comprehensively determine the level of the user 4 after steps S102 to S107 described above are repeated a plurality of times. That is, the level may be determined as A2 after “(3) Level Check Operation” and “(4) Push-up Operation” (the second phases 2 and 3 in FIG. 6) are repeated a plurality of times. In addition, a cooldown phase may be further provided after completion of the ability determination (Cool down after the phase 3 in FIG. 6).

### Effects of Embodiment

According to the embodiment described above, the ability of the user 4 is determined by the ability determination means 105, and a question at a raised level is asked in order to verify the determined ability. In a case where the breakdown detection means 106 detects a breakdown in an answer to the question, it is determined that the ability determined in advance is correct instead of the raised level. In a case where the breakdown detection means 106 detects no breakdown, the ability of the user 4 is determined by further raising the level and continuing the operation. Therefore, a question in consideration of the level of the user 4 (evaluatee) during the ability determination can be asked, and the level can be determined accurately and with certainty by trying other levels.

In addition, since the introduction operation is adopted in which a relatively simple conversation such as a greeting and a small talk is made before the ability determination is performed, it is possible to warm up the user 4 and smoothly shift to the subsequent ability determination operation.

Moreover, since the gesture motion (listening motion, reaction) is imparted during utterance by the avatar and during answer reception, more natural question and answer motions can be made, and eventually, it is possible to encourage self-disclosure of the user and derive information.

In addition, since the level is provisionally determined in units of conversations, topics, or the like, and a question is selected according to this level, it is not necessary to randomly ask all questions as in a case where the level is not provisionally determined, which improves efficiency in terms of time required for questions.

### Another Embodiment

The present invention is not limited to the above embodiments, and various modifications can be made without departing from the gist of the present invention.

The present embodiments may be used for ability determination of other than English conversation, for example, ability determination such as a job interview, mental condition determination, and presentation ability determination. Furthermore, the present embodiments can be applied to a use other than the ability determination, for example, guide uses such as menu selection in a restaurant and tourist spot selection in tourist information. In this case, specifically, the ability determination means 105 is replaced with a preference determination means, the preference of the user is determined from the user's speech, gesture, expression, and the like, and the level is replaced with a menu or a tourist spot.

In the above embodiment, the functions of each of the means 100 to 106 of the control unit 10 are implemented by the program, but all or a part of the means may be implemented by hardware such as an ASIC. In addition, the program employed in the above embodiment can be provided in a state of being stored in a recording medium such as a CD-ROM. Furthermore, replacement, deletion, addition, and the like of the above steps described in the above embodiment can be made within the scope not changing the gist of the present invention.

Moreover, the functions of each of the means 100 to 106 of the control unit 10 of the information processing device 1 are not necessarily realized on the information processing device 1, and may be realized on the terminal 2 within the scope not changing the gist of the present invention. Similarly, the functions of the terminal 2 are not necessarily realized on the terminal 2, and may be realized on the information processing device 1 within the scope not changing the gist of the present invention.

### INDUSTRIAL APPLICABILITY

Provided are the information processing method, the information processing program, and the information processing device for asking a question in consideration of the level of an evaluatee and improving the accuracy of determining the level of the evaluatee.

### REFERENCE SIGNS LIST

1 Information processing device
2 Terminal
3 Network
4 User
10 Control unit
11 Storage unit
12 Communication unit
20 Control unit
21 Storage unit
22 Communication unit
23 Microphone
24 Speaker
25 Camera
26 Display
100 Utterance control means
101 Display control means
102 Motion imparting means
103 Voice recognition means
104 Video recognition means
105 Ability determination means
106 Breakdown detection means
110 Ability determination program
111 Question information
112 Avatar information
113 Motion information
114 Answer information
115 Determination result information

1. An information processing method relating to improve an accuracy of determination of a level of an interlocutor executed by a computer, the method comprising:
an utterance control step of selecting and uttering a question at one level among a plurality of levels determined in advance to the interlocutor;
a detection step of detecting a breakdown of the interlocutor in an answer to the question; and
a determination step of determining the level of the interlocutor on a basis of at least a level at which the breakdown is detected.

2. The information processing method according to claim 1, wherein the breakdown includes any one of incomprehension, non-fluency, or a decrease in grammatical accuracy detected in the answer of the interlocutor.

3. The information processing method according to claim 1, wherein the determination step determines the level of the interlocutor for each unit of the answer to the question, and in a case where the detection step does not detect the breakdown, the utterance control step selects and utters a question at a level higher than the level.

4. The information processing method according to claim 1, wherein in a case where the detection step detects the breakdown, the determination step feedbacks a tentatively determined level to the utterance control step, and the utterance control step selects and utters a question at the tentatively determined level among questions at the plurality of levels.

5. The information processing method according to claim 1, wherein the utterance control step selects and utters a greeting or a small talk as the one level question in an introductory operation.

6. A non-transitory computer-readable medium containing executable instructions for processing information relating to improving an accuracy in determining an interlocutor's level, wherein the instructions, when executed by one or more processors of a computer, causing the computer to:
select and utter a question at one level among a plurality of levels determined in advance to the interlocutor;
detect a breakdown of the interlocutor in an answer to the question; and
determine the level of the interlocutor on a basis of at least a level at which the breakdown is detected.

7. An information processing device comprising:
one or more processors of a computer;
a non-transitory computer-readable medium containing executable instructions for processing information relating to improving an accuracy in determining an interlocutor's level; wherein the instructions, when executed by the one or more processors, further cause the computer to:
select and utter a question at one level among a plurality of levels determined in advance to the interlocutor;
detect a breakdown of the interlocutor in an answer to the question; and
determine the level of the interlocutor on a basis of at least a level at which the breakdown is detected.

8. The information processing method according to claim 1, wherein the breakdown of the interlocutor comprises a deviation of the answer of the interlocutor to the question from a distribution of normal responses.

9. The information processing method according to claim 1, wherein the determination step includes determining the level of the interlocutor's language proficiency.

10. The information processing method according to claim 1, wherein the determination step includes determining any one of the level of the interlocutor's mental condition, conversational ability or preference.

11. The information processing method according to claim 2, wherein the determination step determines the level of the interlocutor for each unit of the answer to the question, and in a case where the detection step does not detect the breakdown, the utterance control step selects and utters a question at a level higher than the level.

12. The information processing method according to claim 2, wherein in a case where the detection step detects the breakdown, the determination step feedbacks a tentatively determined level to the utterance control step, and the utterance control step selects and utters a question at the tentatively determined level among questions at the plurality of levels.

13. The information processing method according to claim 3, wherein in a case where the detection step detects the breakdown, the determination step feedbacks a tentatively determined level to the utterance control step, and the utterance control step selects and utters a question at the tentatively determined level among questions at the plurality of levels.

14. The information processing method according to claim 2, wherein the utterance control step selects and utters a greeting or a small talk as the one level question in an introductory operation.

15. The information processing method according to claim 3, wherein the utterance control step selects and utters a greeting or a small talk as the one level question in an introductory operation.

16. The information processing method according to claim 4, wherein the utterance control step selects and utters a greeting or a small talk as the one level question in an introductory operation.
